(19) United States
(12) Patent Application Publication
(10) Pub. No.: US 2015/0213392 A1
(43) Pub. Date: Jul. 30, 2015

(54) System and Method of Using Task Fingerprinting to Predict Task Performance

(71) Applicant: CARNEGIE MELLON UNIVERSITY, Pittsburgh,, PA (US)

(72) Inventors: Aniket Dilip Kittur, Pittsburgh, PA (US); Jeffrey Mark Rzeszotarski, Chesterland, OH (US)

(73) Assignee: Carnegie Mellon University, Pittsburgh, PA (US)

(21) Appl. No.: 14/431,818

(22) PCT Filed: Sep. 27, 2013
(86) PCT No.: PCT/US13/62140

§ 371 Date: Mar. 27, 2015

Related U.S. Application Data
(60) Provisional application No. 61/744,490, filed on Sep. 27, 2012.

(51) Int. Cl. G06Q 10/06; G06N 5/04

(52) U.S. Cl. CPC G06Q 10/06398; G06N 5/04; G06Q 10/067

(57) ABSTRACT

A novel method of using task fingerprinting to predict outcome measures such quality, errors, and the likelihood of cheating, particularly as applied to crowd sourced tasks. The technique focuses on the way workers work rather than the products they produce. The technique captures behavioral traces from online crowd workers and uses them to build predictive models of task performance. The effectiveness of the approach is evaluated across three contexts including classification, generation, and comprehension tasks.

### RELATED APPLICATIONS

This application claims the benefit of U.S. Provisional Application 61/744,490, filed Sep. 27, 2012.

### GOVERNMENT RIGHTS

This invention was made with government support under NSF No. IIS-0968484. The government has certain rights in this invention.

### BACKGROUND OF THE INVENTION

Crowdsourcing markets like Amazon's Mechanical Turk (MTurk) allow users to rapidly disseminate large quantities of small tasks to a large pool of willing workers. This empowers researchers to assemble large datasets of human labeled corpora, corporations to outsource simple data processing, and even, one day, to have individuals utilize crowdworkers to complete tasks in their own word processors. The ability to quickly and effectively reach a willing microtask work force has the potential to change the way work is done in society. However, the distributed nature of such markets can pose challenges for employers. Because tasks are typically small, short, and high volume, workers can expend minimal effort or even cheat on jobs as their output often blends in with the crowd. This is especially true for subjective tasks or those with multiple valid answers, which can attract cheating rates of over 30%. Adding to this issue is the limited ability to rate workers, for example, by using the reputation system in Mturk, which only tracks the total percentage of work a worker has had accepted; cheaters can slip through and even maintain high reputations by accepting tasks for which they are unlikely to get rejected. Even if workers are not cheating, there can be high variability in the quality of their work due to differences in effort or skill.

Significant research efforts have been made to develop ways to detect and correct for low quality work and to improve the overall quality of the resulting data. Researchers have proposed a variety of approaches to address this issue, ranging from using gold standards to post-hoc weighting based on worker agreement or reputation. Most of these approaches rely on a single aspect of the workflow in human computation markets: the end products. With only the end product of the work process and some minimal reputation metrics about the workers involved, employers must make difficult tradeoffs depending on the quality control method they use. For example, methods based on worker agreement rely on multiple redundant worker judgments, while gold standards require some percentage of labeled data.

There are at least two general approaches researchers have explored for obtaining good data from crowdworkers. Pretask approaches focus on designing tasks so that they are resistant to poor responses. For example, in the context of MTurk, tasks be designed in such a way that performing poorly or cheating is as costly as contributing in good-faith. Other approaches include promoting intrinsical motivation, splitting larger tasks into small, fault-tolerant subtasks, incorporating randomness in cooperative task designs, financial manipulation and tweaking outcome measures. While these can be effective strategies, they require that tasks be specially tailored for the approach.

### BRIEF SUMMARY OF THE INVENTION

The present invention utilizes a novel technique, known as “task fingerprinting”, which focuses on the way workers work rather than the products they produce. This complementary and alternative technique to current technologies captures behavioral traces from online crowd workers and uses them to predict outcome measures such quality, errors, and the likelihood of cheating.

The behavioral traces are collected using an instrumented web page to collect information on various behavioral metrics, such as scrolling, mouse movement, typing, delays, focus, etc. The collected metrics are stored in a database for later analysis and can be used to predict the quality, on an individual or group basis, of the worker's output.

### BRIEF DESCRIPTION OF THE DRAWINGS

FIG. 1 presents example refined event logs for tagging an image with both ‘lazy’ and ‘diligent’ workers. The lazy worker quickly writes simplistic tags, while the diligent worker takes time to think and check the source image between tags.

FIG. 2 illustrates aggregate data collected by the system.

FIG. 3 presents model prediction correlation with actual ratings as training set size increases for image tagging and word identification.

FIG. 4 shows word identification task fingerprint clusters graphed based on the number of fields each user accessed (x) versus the length of their collapsed event log (y). Notice that the blue and teal clusters discriminate between pass and failure well. The red cluster encapsulates borderline points, while the diffuse purple cluster gathers diffused ‘pass’ points.

FIG. 5 is a schematic view of one embodiment of a system used to implement the current invention.

### DETAILED DESCRIPTION OF THE INVENTION

In one embodiment, a technique, called “task fingerprinting”, is used to evaluate task performance on crowdsourcing markets. This is accomplished by examining the way the workers work, rather than the products or output they produce. Task fingerprinting is used to collect and analyze behavioral traces in, for example, online task markets, and can be applied to other applications.

In one example, a task involves a worker performing some actions on an input (typically provided by the employer, resulting in some output. The input might be an image to tag, a document to summarize, or even just a set of guidelines for open response. Using this input, the worker engages in a series of cognitive and motor actions that result in changes in their web browser (e.g., mouse movements, scrolling, keystrokes, time delays, etc.) and produces an end product for the requester. This process can be represented as:

f_{worker}(inputₜₐₛₖ)=output_{task, worker}

where the input is given by the employer, some sequence of cognitive and motor actions are performed by the worker (f_{worker}) on the input, generating some output that is consumed by the employer. Common methods for quality control alter the design of the input or evaluate the output side of the function, since the cognitive effort and skills of the worker are not directly observable. Evaluation based on the process of generating results, however, are effective and result in a number of benefits. In contrast to gold standard approaches, inferences can be drawn about the quality of the output even without labeled data, or even without having to inspect the output at all. Unlike output agreement approaches, predictions of quality can be made without many redundant judgments from different workers. Furthermore, assuming workers are consistent in their behaviors across tasks (which is examined in more detail later), information about their work process can be used on one task to make inferences about their work on other tasks. For example, workers that ignore guidelines of one task can be identified so as to flag all of their work across all tasks for closer examination.

In one embodiment, task fingerprints can have a variety of structures to quantitatively describe what workers do. In their raw form, they are sequential logs of interface events; what the workers did, and when. The sequences encode valuable information, such as the order of operations, time delays between actions, and patterns of labor. Refining this raw data, summary statistical data is gathered, such as counts of different actions or the occurrence of outlier behaviors, such as copy-pasting, that can be used to compare workers. Machine learning based on the input and fingerprint is used to infer characteristics of the output, such as its probable quality or the likelihood that the worker was cheating. In another aspect of the invention, visualization of the fingerprints enables human outlier and pattern detection in large sets of workers.

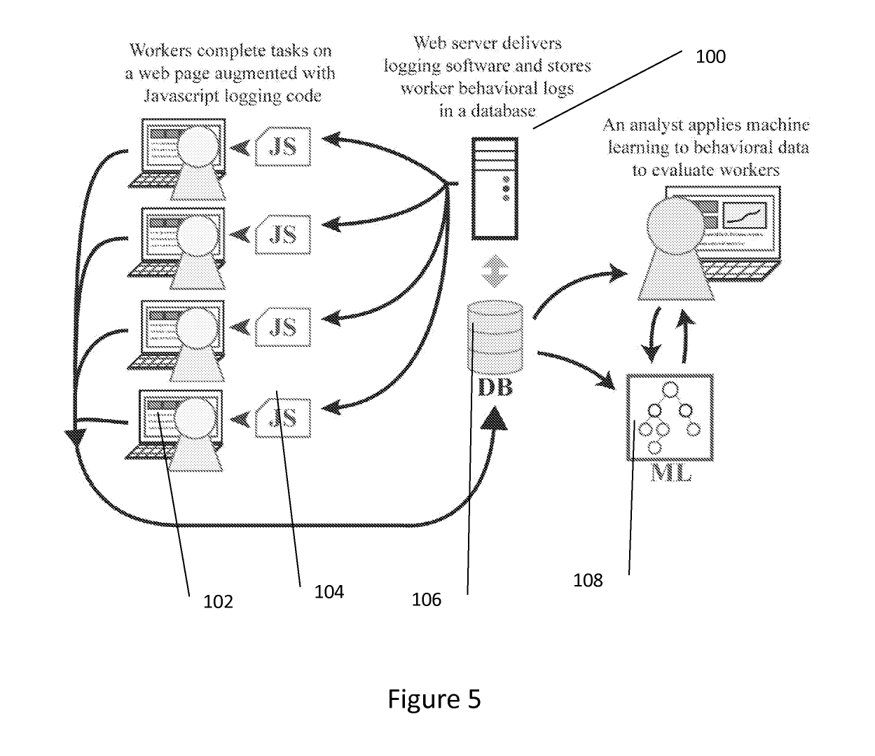

In one embodiment, shown in FIG. 5, a task fingerprinting system is created that uses an instrumented web browser running on a standard personal computer 102 connected to a local area or wide area network, such as the Internet, to collect metrics regarding the workers' behavior.

An instrumented user interface is used to collect the data. In the preferred embodiment, web server 100 serves the web page of the crowdsourcing market, augmented using Javascript and the jQuery library 104, to provide the instrumentation which is used to monitor user activity on the crowdsourcing market web pages. Each time the worker clicks within the page, presses a key, scrolls, changes focus, or moves their mouse, an event is triggered and recorded to a list in data store 106, along with a unique user hash, a page hash, event information such as mouse position or which key was pressed, and a timestamp (to the millisecond). After completing the task, the collected log is uploaded to a server, where it can be analyzed using machine language algorithms 108, which are part of the present invention.

Workers may have the option to opt-in or opt-out of participation, through an opt-in button. The server uses, in one embodiment, the Django web framework to record each event in the usage data as a row in an SQLite database (i.e., data store 106) for later analysis. The system is portable and able to log users on any website, however, at the present time, data store 106 must be hosted by the web site, on web server 100, as cross site scripting limitations make uploading log data very difficult otherwise.

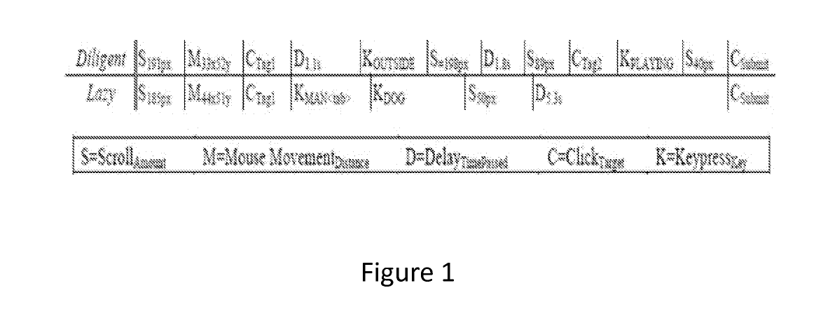

In one embodiment, event logs are discretized on the server to facilitate analysis, with sequences of scrolling and mouse movement encoded into individual events for each, for example, 200 pixels total moved or scrolled. The discretization process consists of several steps. First, repeated sequential events, such as mouse movements or scrolling, are encoded into individual events with aggregate information (total mouse movement from start to end, total scrolled position); this avoids simple “spoofing” attacks such as extended scrolling or mouse movement without other activity (FIG. 1). Second, discretization can miss significant delay information (for example, if the user scrolls, then reads without moving their mouse, then scrolls again). To address this, delay events are used to encode temporal information into the log: if a user waits longer than a specific time threshold (in the preferred embodiment, 200 mSec) a delay event is encoded, with further delay events added for every 200 mSec the user waits.

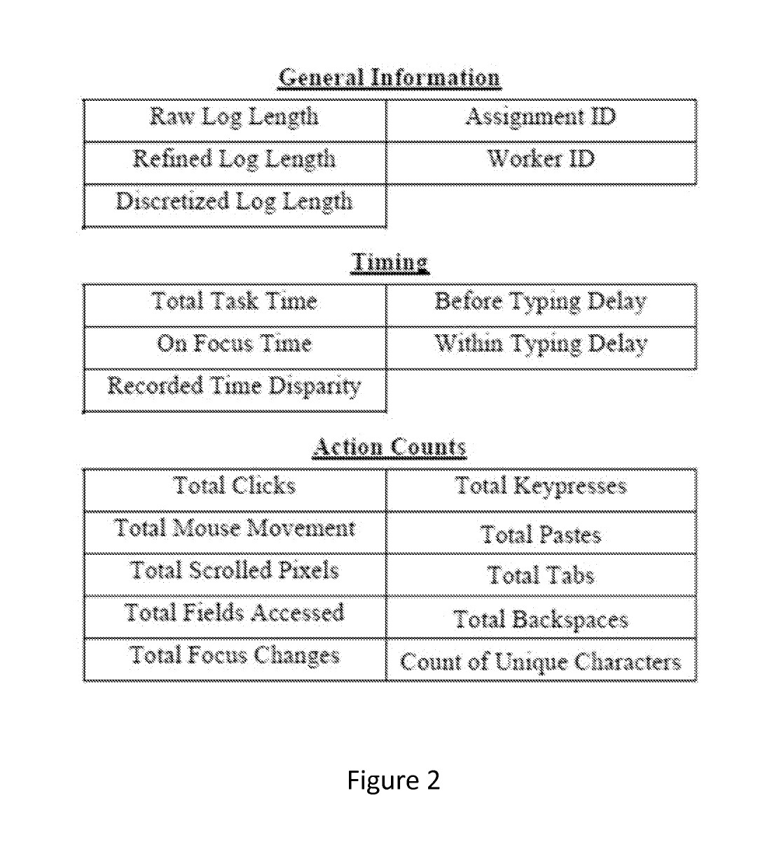

In addition, aggregate, quantitative information is collected that characterizes the user's behavior in a holistic sense (FIG. 2). First, summary data is generated, such as the total time the system was logging activity, the counts of different types of events, the total amount of scrolling and mouse movement, and the lengths of the raw and collapsed event logs. These allow one to see what a user is doing in the environment. Second, more specific information is collected about the events, such as the number of times certain special keys like tab and backspace were used, the number of times a user pastes text, a total count of the number of unique keys a user presses, and how many form fields were accessed. This information can help expose users with especially unique behavioral patterns. Finally, information is collected about the delays the user introduces into their work. In one example, the user's ‘off focus’ length from the page is determined, in addition to the cumulative time they spent before they started typing in a form field, and the cumulative time they spent between keystrokes in a form field. These features are used to make higher level judgments about user deliberation and attention in tasks. For crowdsourcing markets, such as Mechanical Turk, the time the total time spent on the task is incorporated, as well as the worker's unique worker identification.

In one example, Mechanical Turk workers perform data labeling, a type of task often used on human computation markets. Workers are presented with a HIT (Human Intelligence Task) that presents them with a list of 40 words and asks them to check boxes for words that were nouns and leave non-nouns unchecked. On average, each HIT had 11 nouns and 29 verbs, adjectives, or adverbs between 4 and 9 characters, selected from the Moby and Wordnet databases intersected with an English as a second language dictionary, so as to provide easier words. Payment is set at $0.05, somewhat high for a task of its magnitude, such as to encourage cheating and unscrupulous behavior.

In one test of the system, a total of 5 instances of each of 40 different labeling tasks were solicited, totaling 200 requests. Of those 200 requests, 15 were excluded because their browsers did not relay event logs. In one example, twenty-one unique participants generated the remaining 185 points in this task. The participants were evaluated based on the number of ‘correct’ answers they give, where a correct answer means checking a noun and leaving a non-noun unchecked. On average, people correctly classified 83% of words (SD=14.1), compared to an average of 73% if they had left the form completely blank. Because the participant average is below even what would be the case if they only checked half the nouns and left the rest blank (86%), it is likely that a fair percentage of workers put forward a minimum amount of effort.

In one embodiment, machine learning is used to predict the quantitative evaluation of the labels each worker provided using the task fingerprints. First, a binary prediction task is investigated, using a pass/fail threshold of, in one example, 80% (where “pass” corresponds to a generous threshold of identifying 3 nouns accurately with no non-nouns checked; 69 of 185 participants fail this milestone and 116 pass). This threshold also is consistent with the 30% cheating ratio found by other crowdsourcing researchers. After identifying the most predictive feature, machine learning algorithms for solving data mining problems (such as Weka), are used to generate decision trees to predict the pass/fail classification.

A number of features are used in the decision trees to maximize generality and avoid overfitting. The initial tree utilized the number of clicks, checkboxes accessed, and the difference between the Turk recorded time and our event log time. Using 10-fold crossvalidation, the model predicted the pass/fail evaluation for the 185 data points with 83.2% accuracy, a kappa of 0.608, and an F-measure of 0.823. This shows that such a model can highlight points of interest for exclusion or human inspection. However, since many of the checkboxes are correct in their default unchecked form, the possibility exists that the number of fields accessed may be too directly tied to our choice of leaving nouns in the minority. Removing those fields, a decision tree was generated that utilized the total amount a user scrolls and moves the mouse as well as the disparity between recorded task times. This model, using only summary statistics about the user's behavior, classified the points with 78.3% accuracy, a kappa of 0.534, and an F-measure of 0.784, reinforcing our suggestion that even with limited fingerprint data, a model could highlight questionable points in a large sample of end products.

Beyond classifying workers' products as suspect, we investigated whether we could predict the raw accuracy score of a given worker using only their fingerprint. Using support vector regression, we trained models from the fingerprints and accuracy scores. Under 10-fold cross-validation, our model significantly correlated with the actual accuracies we recorded (r=0.3289, p<0.001). This suggests the model may be suitable for identifying high quality work in a large sample of completed submissions. By incorporating worker identity, the model is further improved, boosting the correlation higher (r=0.8926, p<0.001). Similarly, adding worker identity and predicting a pass/fail score using a decision tree without clicks classifies better than our previous classifier, having an accuracy of 85.4%, a kappa of 0.681, and an F-measure of 0.856. Examining the trees, it is clear that accounting for intra-worker variance has significant benefits, since workers seem to produce similar quality work across multiple iterations of the task.

In one example, to investigate content generation HITs on Mechanical Turk, workers were supplied three to five keyword tags for each of four images. Three different sets of images were generated based on three themes: art, pets, and landscapes. For each of the themes, 20 submissions were solicited. To gather more variance, a duplicate set of the series of tasks was generated, this time explicitly asking for workers to pretend they were clever cheaters. Their new task was to try to complete the same tagging task with the minimum of effort needed to avoid being caught by an inattentive requester. A similar group of 20 submissions was requested for each image set under this condition. The examinations of the end products revealed that this ‘cheating’ group in fact produced many acceptable submissions, suggesting that some of the workers may not have comprehended the nature of the cheating task or that “clever” cheating may actually have been more difficult than doing the task in good faith. As a result, the two datasets were combined into one that represent a broader range of work quality. Of the 120 submissions, 6 were excluded because no event logs are received. The remaining 114 points represent the work of 52 unique participants.

Unlike in the noun identification task, the gold standard images and tags are not present to provide a quantitative evaluation. Instead, two raters examine each group of tags with respect to the set of images and judge them on two five point scales. The first scale concerned the quantity of work done, where a value of 1 represented clear cheating or no work completed, 3 meant an adequate amount of work according to the HIT directions, and 5 represented exceptional effort. The second scale concerned the descriptiveness of completed work, where 1 corresponded to poor quality, specious, or empty tags, 3 represented tags that accurately described the images, and 5 meant exceptionally descriptive tags. The raters rated the 114 points with high interrater reliability (Spearman's ρ=0.7541, 0.7636; p<0.001, p<0.001 respectively). The two scales are correlated, suggesting they indeed measure an innate quality aspect of the task results, as confirmed by their high item reliability (Cronbach's α=0.8248). As a result, the results of the two scales are averaged into one rating for general performance, and of the 114 points, the rating for submissions averaged to 3.5 out of 5 (SD=1.13). The raters decided by consensus from the submitted tags whether a submission represented cheating. Of the points, 17, or 14.1%, are identified as clear cheats. This proportion is smaller than in our previous experiment, likely because the task was more complex and there were a small number of tasks to complete in series, thus making them less attractive to potential cheaters.

Task fingerprints are constructed as before from the logs, which averaged 107.9 events. On average, the workers spent 2 minutes, 32 seconds on the task, spending in total an average of 39.7 seconds before they typed a tag in a field, and 30.3 seconds typing their tags. On average, they used 20.5 different characters and typed 105.8 keystrokes. The Mechanical Turk system reported times that were on average 27.1 seconds longer than our recorded on-task time.

In one example, the task fingerprints for image tagging are used to predict whether a person cheated or not using a logistic decision tree. The resulting tree weighted primarily for the number of unique ASCII characters used and the total time spent on the task. Under 10-fold crossvalidation it achieved 93.0% accuracy, a kappa of 0.655, and an F measure of 0.930 using only those two attributes. In this example, tree structure shows that cheaters use fewer unique keyboard keys (leading to fewer distinct tags) and take less time to complete the task than non-cheaters.

In one example, support vector regression on the task fingerprints is used to predict the rated quality of the results. The resulting model significantly predicts quality (correlation with actual ratings: r=0.5874, p<0.001). It shows that the more fields accessed, more unique characters, fewer total key presses, more clicks, and more total time spent predict higher scores. In summary, the model shows how good tags will be without knowledge of the tags themselves.

In another example, the system was examined to see if it could predict high quality outcomes, as opposed to just cheaters and low quality output. After filtering the data to only acceptable submissions and higher, support vector regression to the remaining 81 high scoring points was applied. Once again, the model is highly correlated with the actual scores (r=0.4598, p<0.001). Thus, given only high quality data, the quality rating of submitted tags can be predicted.

In this example, the results showed that even for qualitative, generative tasks like image tagging, task fingerprints encode information that can help identify cheaters and predict the quality of the tags produced. The predictions relied on low-fidelity statistical information, such as the number of unique keys used and the total time on task.

In yet another example, reading comprehension was used to evaluate task fingerprinting in complex cognitive work on Mechanical Turk. The task fingerprint is used to predict the performance of workers on the task. In this example, the performance measure is the number of correct answers a worker entered, which approximates their overall learning and comprehension from the passage. Using support vector regression, task fingerprints significantly predicted the comprehension level of Turkers (r=0.260, p=0.0393). The predictive model depended largely on the time spent on focus, the difference between the recorded HIT time and our event log time, the total mouse and scroll movement, the number of clicks, and the delay between typing characters in the short response. The typing delay might relate to the fact that many successful submissions copy-pasted their answer to the short answer question from the passage. This produces a zero typing delay, which explains the negative relation between delay and number correct. Mouse movement and scrolling might capture the behavior of workers that often refer to the passage when answering questions. Based on these findings, task fingerprints are shown to hold predictive value for higher cognitive tasks and functions in crowd workers.

In the previous examples, fully labeled data is utilized. It is likely to be the case that the data used for crowdsourcing is neither perfect nor gold standard. More often than not, it is likely to be unlabeled and hard to evaluate by hand. Three different means are given to reduce the burden on requesters in actually applying task fingerprinting to crowdsourced tasks.

In one example, test runs are conducted of the image tagging and word identification data training on only small randomly selected proportions of the total labeled data points. If the methods are able to predict the rest of the dataset with reasonable accuracy, then it is likely that requesters need not label their entire dataset. Rather, they need only label a small subset to provide the necessary training for a task fingerprint predictor. In the case of image tagging, a qualitative performance rating support vector regression model is trained using 5% through 60% of the data, in increments of ten percent, averaging 20 runs that use a different random selection of data points each time. Although the model cannot significantly predict performance using 5% and 10% of the data, for 20% of the data (23 points) and above the model predictions significantly correlate to the actual ratings. There is enough data in the task fingerprints that a small sample and a generalized machine learning model can provide good accuracy. Running a similar prediction for accuracy in our word identification task reinforces this: Once again, in one example, from 20% of the data (37 points) onwards the model's predictions correlated with significance to the actual accuracy values. Thus, one way to avoid being overburdened with labeling is to simply label a selection of random points, create a classifier using the task fingerprints, and examine selected results to ensure it is behaving appropriately.

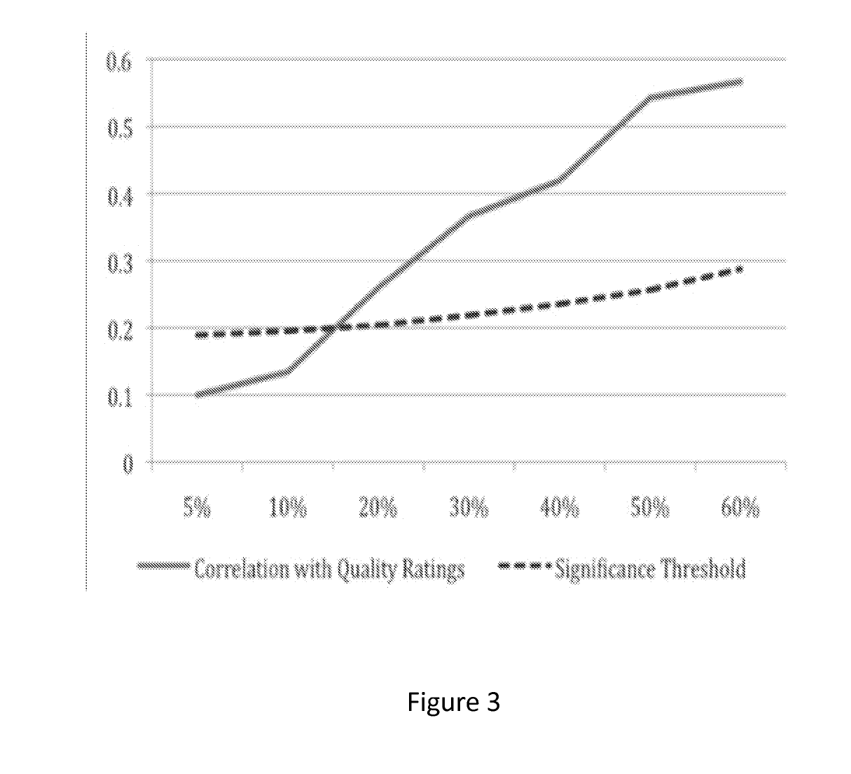

However, labeling data may not be possible for all datasets and tasks. Yet, some tasks are similar to other tasks in Mechanical Turk. For instance, the reading comprehension task involves workers examining a passage and then clicking on multiple choice boxes. After all of the task fingerprint values are normalized for both reading comprehension and word identification, a support vector regression model is trained on all of the normalized counts of correct answers in the reading comprehension problem. This model is then applied to the entirety of the word identification dataset, predicting its normalized count of correct answers. The model is able to significantly predict correct answers in the new dataset (r=0.4948, p<0.001) (FIG. 3). Thus, if one had gold standard data for a congruent task, one may be able to gather task fingerprints for the benchmark job and then apply the model to evaluate a related different task without labels. It is particularly surprising how well the model generalized given the fundamental differences in the nature of the tasks: reading a passage and answering multiple choice questions versus identifying nouns in a word list. Building up a toolbox of archetypal task fingerprints for model training may enable prediction for a variety of tasks and evaluations.

It is possible that even in the absence of any labeled data, a mixed-initiative approach starting with unsupervised clustering can be used to bootstrap the system. By visualizing features that differ between clusters (e.g., number of fields clicked on, time on task) employers can identify potential outliers and after investigation label the cheaters; such labels can then be leveraged by the system for the unlabeled data.

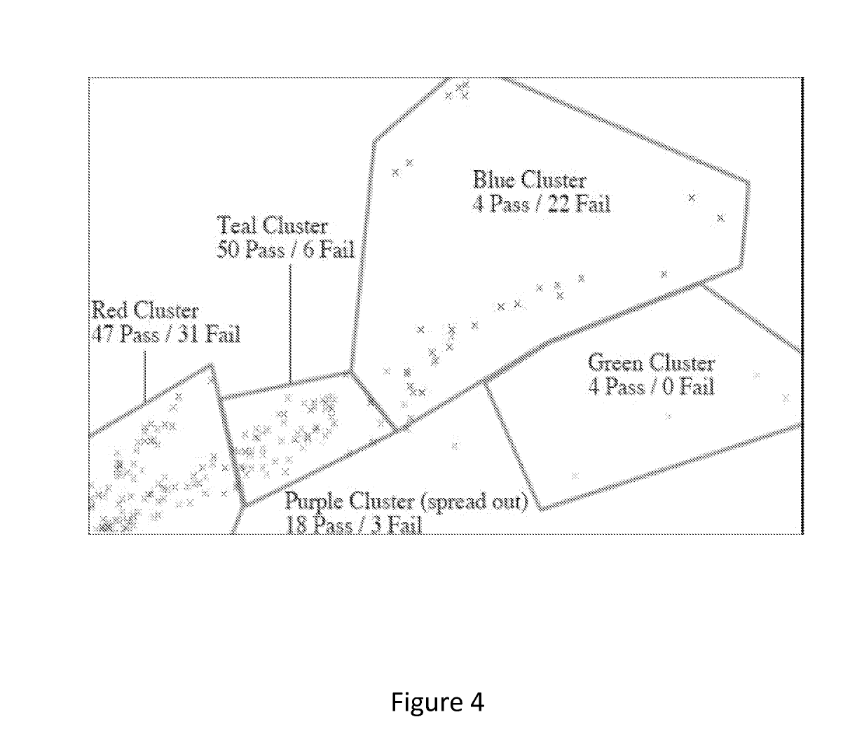

In one example, the feasibility of unsupervised clustering of task fingerprints is tested. By using the word identification task, the points of labels are stripped and used expectation maximization to identify 5 clusters of fingerprints. Four of the clusters corresponded to high likelihoods of either high or low performance workers, while one cluster was split, warranting manual inspection. FIG. 4 shows a visualization of the clusters on two dimensions (fields accessed and collapsed log length); this shows a mixed initiative system in which the user could inspect representative cluster samples and outliers, bootstrapping the classification process.

In one example, fingerprinting affects ‘botting’, or automated task completion on markets. This is identified by using event log pattern detection, for example examining the variance of the workers' behavior (e.g., using string comparison methods like minimum edit distance on refined event logs, or temporal variance measures). This approach is even more powerful if requesters share the fingerprints of known bots as they emerge (e.g., as antivirus companies do with virus hashes). More varied tasks, including ones where workers might spend significantly different amounts of time and effort on a task can be tested to reinforce the consistency and comparability of fingerprints across workers and tasks. Clustering of task fingerprints not based on statistical data, but rather the conformation of the event log strings using bioinformatics algorithms can also yield useful behavioral information.

The present methodology of harnessing workers' implicit behaviors provides a number of advantages over other approaches. First, models of user behavior can generalize across tasks. Second, collecting additional data about the worker's behavior has the potential to improve predictions beyond the theoretical limits of just using a worker's identity and their end products. Third, the method does not require knowledge of ‘correct’ answers, and supports having a range of valid answers. Fourth, it can scale down to a small worker pool, making judgments even about individual workers.

In one example, task fingerprints are combined with other forms of task performance predictors. Those skilled in the art will recognize that other types of task fingerprint applications exist, unrelated to crowd sourcing applications. For example, any type of software application or device driven by embedded software may be instrumented to collect the appropriate behavioral metrics necessary to evaluate the effectiveness of the worker.

We claim:

1. A method for creating a task fingerprint comprising the steps of:
assigning a task to one or more workers;
collecting data regarding metrics related to the behavioral characteristics of a subset of said one or more workers during the completion of said task;
identifying, from said collected data, certain behavioral characteristics associated with desired output from the completion of said task by said subset of workers;
creating a model of desired behavior based on said identified behavioral characteristics; and;
using said model of desired behavior to evaluate said one or more workers.

2. The method of claim 1 wherein said model is used to evaluate said one or more workers for the present task or for a future task.

3. The method of claim 1 wherein said collecting data step used an instrumented user interface to collect said data.

4. The method of claim 3 wherein said instrumented user interface is a web page served by a web server, which is accessible through a web browser running on a computer connected to a wide area network, and further wherein said task is completed by said one or more workers using said web page.

5. The method of claim 4 wherein said metrics are collected using software served by said web page server and running on said web browser.

6. The method of claim 3 wherein said data is stored in a data store on said web server.

7. The method of claim 6 wherein said data store is a database.

8. The method of claim 1 wherein said metrics related to behavioral characteristics comprise user interface events.

9. The method of claim 8 wherein said user interface events include scrolling, mouse movements, mouse clicks, focus events, typing and delay events.

10. The method of claim 9 wherein said scrolling and mouse movements are discretized into a series of individual events.

11. The method of claim 8 wherein each of said user interface events includes a timestamp and a user identifier.

12. The method of claim 8 wherein said collected data may be summarized to create holistic metrics regarding said user's behavioral characteristics and further wherein said holistic metrics are correlated with said desired output to create said model of desired behavior.

13. The method of claim 1 wherein said model of desired behavior is created by providing a statistical correlation between said desired output and said certain behavioral characteristics associated with said desired output.

14. The method of claim 1 wherein said identifying step comprises manually or algorithmically evaluating the output produced by said subset of workers to identify workers producing said desired output.

15. The method of claim 1 wherein said identifying step comprises identifying workers having desired behavioral characteristics by comparing each worker's output to a gold standard output.

16. A system for creating a task fingerprint comprising:
a computer;
an instrumented user interface generated by said computer, in which users are assigned a task to complete, said instrumented user interface including code to collect user interface events;
a data store, accessible to said instrumented user interface, into which said user interface events and stored; and
software running on said computer, said software performing the function of collecting data regarding metrics related to the behavioral characteristics of a subset of said one or more workers during the completion of said task.

17. The system of claim 16 wherein said instrumented user interface is a web server serving a web page.

18. The system of claim 16 wherein said data store is a database.

19. The system of claim 16, wherein said task fingerprint is created using said collected data by:
identifying from said collected data, certain behavioral characteristics associated with desired output from the completion of said task by said subset of workers;
creating a model of desired behavior based on said identified behavioral characteristics; and;
using said model of desired behavior to evaluate said one or more workers.

20. The system of claim 19 wherein said collected data includes user interface events and summary data.
